(19) United States
(12) Patent Application Publication
(10) Pub. No.: US 2025/0172766 A1
(43) Pub. Date: May 29, 2025

(54) OPTICAL FIBER CONNECTOR, PHOTONIC INTEGRATED CIRCUIT AND PHOTONIC PACKAGING STRUCTURE USING THE SAME

(71) Applicant: Taiwan Semiconductor Manufacturing Company, Ltd., Hsinchu (TW)

(72) Inventors: Tai-Chun Huang, Hsinchu (TW); Stefan Rusu, Sunnyvale, CA (US)

(73) Assignee: Taiwan Semiconductor Manufacturing Company, Ltd., Hsinchu (TW)

(21) Appl. No.: 18/522,479

(22) Filed: Nov. 29, 2023

(51) Int. Cl. G02B 6/38; G02B 6/42

(52) U.S. Cl. CPC G02B 6/3886; G02B 6/4292

(57) ABSTRACT

An optical fiber connector, a photonic integrated circuit and a photonic packaging structure using the same are provided. The optical fiber connector includes a body, a plurality of optical fibers and an alignment component. The body has an interface. The optical fibers are arranged in the body, and the optical fibers are arranged in a first direction of the interface. The alignment component is disposed on the interface and is located on at least one side of the interface in the first direction. The alignment component is configured for the optical fiber connector to be magnetically attracted to another alignment component.

### BACKGROUND

In the past, optical packaging has always been a major challenge. In addition, grating coupler was commonly used for the input and output of light. However, due to the inherent characteristics of grating coupler, there are certain limitations on the bandwidth and loss of light spectrum. In addition, aligning and adjusting the angle of incidence during packaging is also a significant challenge. Furthermore, traditional packaging involves applying optical glue between interfaces and fixing the optical fibers with UV light, but this method affects the freedom of calibration of the optical fibers. If actual production and mass production are required, it is difficult to ensure the reliability and quality of production.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an internal schematic diagram of a photonic integrated circuit according to an embodiment of the present disclosure.

FIGS. 2A to 2C respectively illustrate schematic diagrams of a combination of an optical fiber connector and a photonic integrated circuit according to an embodiment of the present disclosure.

FIGS. 3A and 3B respectively illustrate schematic diagrams of magnetic attraction between an optical fiber connector and a photonic integrated circuit according to an embodiment of the present disclosure.

FIGS. 4A, 4B and 4C respectively illustrate schematic diagrams of two alignment components respectively disposed on an optical fiber connector and a photonic integrated circuit according to an embodiment of the present disclosure.

FIGS. 5A, 5B and 5C respectively illustrate schematic diagrams of two alignment components respectively disposed on an optical fiber connector and a photonic integrated circuit according to an embodiment of the present disclosure.

FIGS. 6A and 6B respectively illustrate the configuration of a waveguide according to an embodiment of the present disclosure.

FIGS. 7A to 7C respectively illustrate a schematic diagram of a photonic packaging structure according to an embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The present disclosure provides a structure for optically aligning an optical fiber to a photonic component (e.g., a waveguide) to achieve precise optical alignment between the optical fiber and the photonic component.

Photonic Integrated Circuit (PIC) is made by semiconductor process technology to integrate photonic components onto a chip, using “light” as a signal to transmit digital data, achieving high-speed photoelectric conversion, reducing the size of the chip module, and reducing power consumption. The PIC application range covers optical communication transmission, optical sensing systems, smart Internet of things, quantum computing and other fields. Photonic components are generally divided into two types of components. One type is passive optical components, which are components responsible for transmitting, dividing, coupling, filtering or attenuating optical signals, such as optical waveguides, grating couplers, ring resonant cavities, etc.; the other type active optoelectronic components are components that use electrical energy to generate, drive or modulate optical signals, such as lasers, electro-optical modulators, thermally tuned waveguides, light sensors, etc. In addition, the photonic integrated circuit integrates photonic active and passive components, such as optical transceiver modules, equalizers, wavelength demultiplexers, etc., to observe the overall response of the system in the time domain and frequency domain.

The coupler is a device that couples photonic integrated circuits and the optical fibers to each other. The most difficult part in the coupling process is the mismatch in the size of the optical modes between the PIC and the optical fibers. The optical modes in PIC is about a few hundred nanometers in size, while the optical modes in optical fibers are several microns in size. The couplers can generally be divided into two types based on the relative positions of optical fibers and the photonic integrated circuit. One is planar coupling, also called edge coupler, which means that the optical fiber and the photonic integrated circuit are located on the same plane, the optical fiber is located on the side of the PIC chip and coupled through tapered waveguides. The other one is vertical coupling, which is the so-called grating coupler (GC). The grating coupler uses the diffraction effect of the grating for coupling. For different orders of diffraction, the diffraction direction of light is different, so the grating coupler can be used as an element to change the direction of the light to couple the light into the optical fiber in the vertical direction.

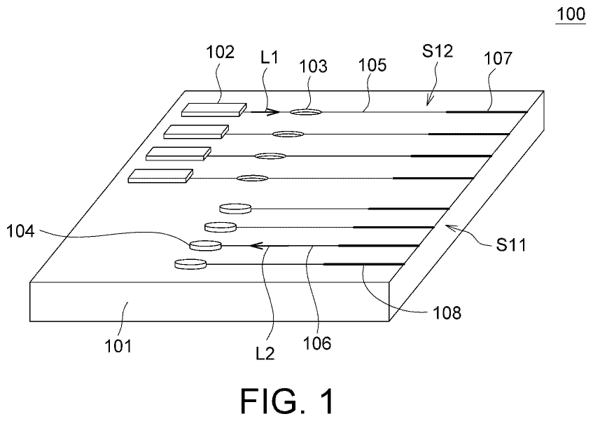

Referring to FIG. 1, an internal schematic diagram of a photonic integrated circuit 100 according to an embodiment of the present disclosure is illustrated. The photonic integrated circuit 100 has, for example, a first body 101, laser light sources 102, modulators 103, photodetectors 104, silicon waveguides 105 and 106, and edge couplers 107 and/or grating couplers 108. The modulator 103 is, for example, a Mach-Zehnder interferometer. The light detector 104 is, for example, a photodiode or other suitable light detection element. In one embodiment, the optical signal L1 (such as infrared light) emitted by the laser light source 102 can pass through the modulator 103, the silicon waveguide 105 and the edge coupler 107 in sequence to be coupled with the optical fiber through the edge coupler 107 to perform optical communication. In addition, the optical signal L2 transmitted through the external optical fiber can be transmitted to the photodetector 104 through the edge coupler 108 and the silicon waveguide 106 in sequence, and the optical signal L2 is converted into an electrical signal through the photodetector 104 for optoelectronic communication.

In some embodiments, the body 101 is a buried oxide (“BOX”) substrate. The BOX substrate includes an oxide layer and a silicon layer formed over the oxide layer. The substrate may be, for example, a material such as a glass, ceramic, dielectric, a semiconductor, the like, or a combination thereof. In some embodiments, the substrate may be a semiconductor substrate, such as a bulk semiconductor or the like, which may be doped (e.g., with a p-type or an n-type dopant) or undoped. The substrate may be a wafer, such as a silicon wafer. The oxide layer may be, for example, a silicon oxide or the like. In some embodiments, the oxide layer may have a thickness between about 0.5 μm and about 4 μm, in some embodiments. The silicon layer may have a thickness between about 0.1 μm and about 1.5 μm.

The silicon layer is patterned to form silicon regions for waveguides 105 and 106, edge couplers 107, and grating couplers 108. The silicon layer may be patterned using suitable photolithography and etching techniques. The photonic components may be integrated with the waveguides 106, and may be formed with the silicon waveguides 106. The photonic components may be optically coupled to the waveguides 106 to interact with optical signals within the waveguides 106. The photonic components may include, for example, photodetectors 104 and/or modulators 103. In other embodiments, the photonic components may include other active or passive components, such as laser diodes 102, optical signal splitters, or other types of photonic structures or devices. In some embodiments, the photodetectors 104 may be formed by, for example, partially etching regions of the waveguides 106 and growing an epitaxial material on the remaining silicon of the etched regions. The waveguides 106 may be etched using acceptable photolithography and etching techniques. The epitaxial material may comprise, for example, a semiconductor material such as germanium (Ge), which may be doped or undoped. In some embodiments, the modulators 103 may be formed by, for example, partially etching regions of the waveguides 106 and then implanting appropriate dopants within the remaining silicon of the etched regions. The silicon of the etched regions may be doped with p-type dopants, n-type dopants, or a combination.

In some embodiments, one or more edge couplers 107 and grating couplers 108 may be integrated with the waveguides 106. The grating couplers 108 are photonic structures that allow optical signals and/or optical power to be transferred between the waveguides 106 and a photonic component such as a vertically-mounted optical fiber or a waveguide of another photonic system. The grating couplers 108 may be formed using acceptable photolithography and etching techniques. In an embodiment, the grating couplers 108 are formed after the waveguides 106 are defined. For example, a photoresist may be formed on the waveguides 106 and patterned. The photoresist may be patterned with openings corresponding to the grating couplers 108. One or more etching processes may be performed using the patterned photoresist as an etching mask to form recesses in the waveguides 106 that define the grating couplers 108. The edge couplers 107 may also be formed that allow optical signals and/or optical power to be transferred between the waveguide 106 and a photonic component that is horizontally mounted near a sidewall of the photonic integrated circuit 100.

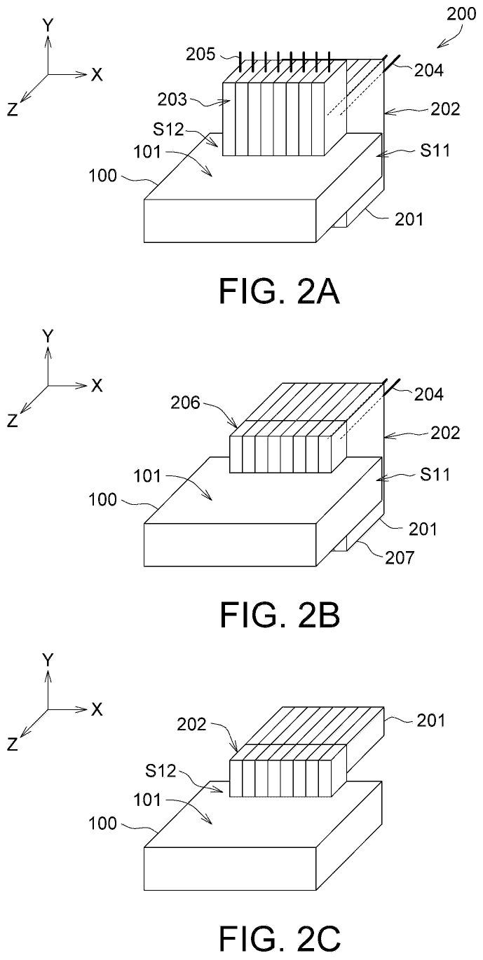

Referring to FIGS. 2A to 2C, schematic diagrams of a combination of an optical fiber connector 200 and a photonic integrated circuit 100 according to an embodiment of the present disclosure are illustrated respectively. In FIG. 2A, the optical fiber connector 200 includes a second body 201, a first optical coupling part 202 and a second optical coupling part 203. The first optical coupling part 202 and the second optical coupling part 203 respectively have a plurality of first optical fibers 204 and a plurality of second optical fibers 205, and the first optical fibers 204 and the second optical fibers 205 are substantially perpendicular. In addition, the photonic integrated circuit 100 includes a first body 101, a first interface S11 and a second interface S12. The first interface S11 and the second interface S12 are substantially perpendicular. The second body 201 is disposed on the first body 101. The second body 201 is connected to the first interface S11 through the first optical coupling part 202 (for example, through magnetic attraction or other detachable methods), and the second body 201 is connected to the second interface S12 through the second optical coupling part 203 (for example, by magnetic attraction or other detachable methods). In one embodiment, the optical signal can be coupled to the optical fiber connector 200 through the edge couplers 107 to couple the light into the first optical coupling part 202 in the horizontal direction (e.g., Z direction), or, the light can change the direction of the light through the grating couplers 108 to couple the light into the second optical coupling part 203 in the vertical direction (e.g., Y direction). In another embodiment, the optical signal can also be coupled to the optical fiber connector 200 through the edge couplers 107 and the grating couplers 108 respectively, so as to couple the light to the first optical coupling part 202 in the horizontal direction and the second optical coupling part 203 in the vertical direction.

In FIG. 2B, the optical fiber connector 200 includes a second body 201, a first optical coupling part 202, a first buckling part 206 and a second buckling part 207, and the first buckling part 206 and the second buckling part 207 are located on opposite sides of the second body 201, and the first body 101 is located between the first buckling part 206 and the second buckling part 207, so that the second body 201 can buckle with the first body 101 through the first buckling part. 206 and the second buckling part 207. The second body 201 is connected to the first interface S11 through the first optical coupling part 202 (for example, by magnetic attraction or other detachable means). In addition, the optical signal can be coupled to the optical fiber connector 200 through the edge couplers 107 to couple the light into the first optical coupling part 202 in the horizontal direction.

In addition, in FIG. 2C, the optical fiber connector 200 includes a second body 201 and a first optical coupling part 202. The second body 201 is connected to the second interface S12 through the first optical coupling part 202 (for example, by magnetic attraction or other detachable methods), and the optical signal can change the direction of the light through the grating coupler 108 to couple the light to the first optical coupling part 202 in the vertical direction.

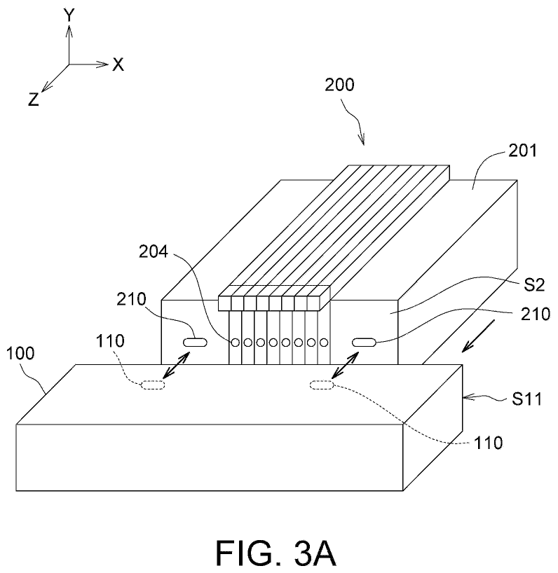

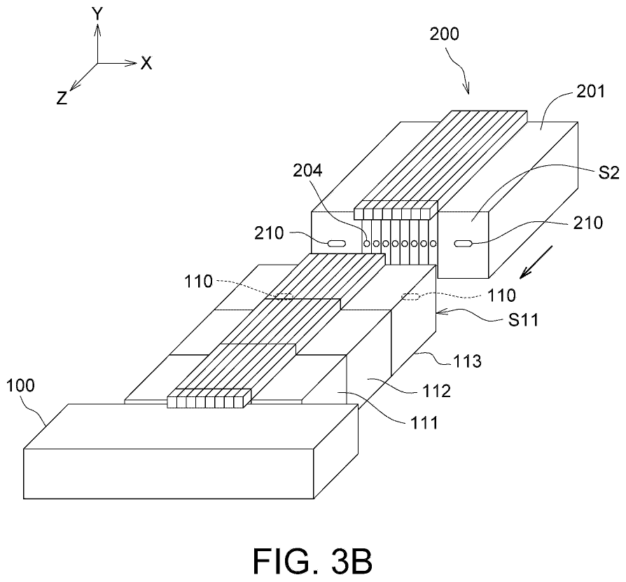

Referring to FIGS. 3A and 3B, schematic diagrams of magnetic attraction between the optical fiber connector 200 and the photonic integrated circuit 100 according to an embodiment of the present disclosure are illustrated respectively. In FIG. 3A, the optical fiber connector 200 includes a second body 201, a plurality of optical fibers 204 and a second alignment component 210. The second body 201 has a first interface S2. The optical fibers 204 are disposed in the second body 201, and the optical fibers 204 are arranged in a first direction X of the first interface S2. The second alignment component 210 is disposed on the first interface S2 and is located on at least one side of the first interface S2 in the first direction X. The first alignment component 210 is configured for the optical fiber connector 200 to be magnetically attracted to the first alignment component 110.

In one embodiment, the two alignment components 110 and 210 are, for example, magnets or magnetic material, which are located outside the optical fibers 204 and attract to each other, so that the optical fiber connector 200 and photonic elements (e.g., waveguide 106) of the photonic integrated circuit 100 are aligned. That is to say, the two alignment components 110 and 210 are aligned with each other in the first direction X, and can slightly adjust the position of the optical fiber connector 200 in a second direction Y perpendicular to the first direction X, so as to improve precision.

In FIG. 3B, at least one matching element 111 to 113 (three are shown in the FIG. 3B) can be included between the optical fiber connector 200 and the photonic integrated circuit 100, so that the refractive indices of the optical fiber connector 200 and the photonic integrated circuit 100 is matched. In one embodiment, the refractive index of the waveguide 106 of the photonic integrated circuit 100 is, for example, between 3.2 and 3.6, and the refractive index of the optical fiber 204 is, for example, between 1 and 1.4. In order to avoid power loss caused by refractive index mismatch between heterogeneous interfaces, a plurality of matching elements 111 to 113 are arranged along a third direction Z perpendicular to the first direction X, wherein the first matching element 111 has, for example, a first refractive index, the second matching element 112 has, for example, a second refractive index, and the third matching element 113 has, for example, a third refractive index. The first refractive index is, for example, between 3.0 and 3.2, which is close to the refractive index of the waveguide 106. The second refractive index is, for example, between 2.0 and 3.0, and the second refractive index is smaller than the first refractive index. The third refractive index is, for example, between 1.4 and 2.0, and the third refractive index is smaller than the second refractive index and close to the refractive index of the optical fiber 204. That is to say, a plurality of matching elements 111 to 113 with refractive index from large to small are arranged in sequence between the photonic integrated circuit 100 and the optical fiber connector 200, which can effectively avoid the return loss due to the refractive index mismatch between the optical fiber 204 and the waveguide 106 during the light transmission process.

In one embodiment, at least one matching element 111 to 113 (also called extenders) extends from the photonic integrated circuit 100 in the third direction Z, so that there is more connection space between the optical fiber connector 200 and the photonic integrated circuit 100. In addition, the first matching element 111 and the photonic integrated circuit 100 as well as the plurality of matching elements 111 to 113 can be fixedly connected through UV glue or other non-detachable means to ensure the quality and stability of light transmission. In addition, the third matching element 113 and the optical fiber connector 200 can be connected through magnetic attraction or other detachable methods. At this time, the first alignment component 110 can be disposed on the interface S11 of the third matching element 113; thereby the alignment accuracy between the optical fiber connector 200 and the photonic integrated circuit 100 is adjusted. In this way, the user only needs to connect the first interface S2 of the optical fiber connector 200 to the matching elements 111 to 113, and then connect the matching elements 111 to 113 to the photonic integrated circuit 100 to complete the installation, and the problems of insufficient connection space and poor reliability and stability of optical transmission can be solved.

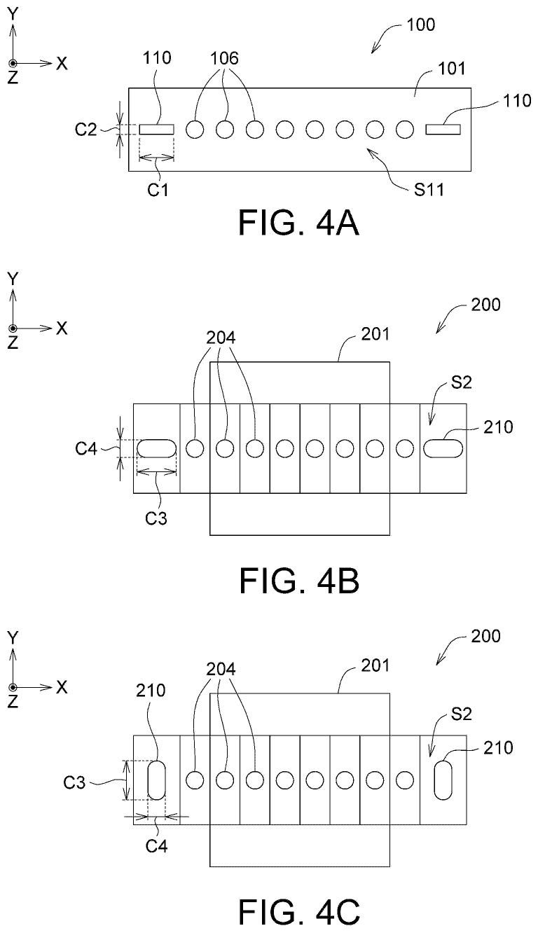

Referring to FIGS. 4A, 4B and 4C, schematic diagrams of two alignment components disposed on the optical fiber connector 200 and the photonic integrated circuit 100 according to an embodiment of the present disclosure are illustrated respectively. In FIG. 4A, the photonic integrated circuit 100 includes a first body 101, a plurality of waveguides 106 and a first alignment component 110. The first body 101 has a first interface S11. The waveguides 106 are disposed in the first body 101, and the waveguides 106 are arranged in a first direction X of the first interface S11. The first alignment component 110 is disposed on the first interface S11 and is located on at least one side of the first interface S11 in the first direction X. The first alignment component 110 is configured for the photonic integrated circuit 100 to be magnetically attracted to the second alignment component 210.

Referring to FIG. 4A, the first alignment component 110 may include two magnets, which are respectively disposed on the outermost sides of the waveguides 106. The first alignment component 110 may be of any shape, such as a rectangle, a square, a circle or a triangle. The first alignment component 110 has, for example, a long side and a short side. The size C1 of the long side is larger than the size C2 of the short side. The long side may extend along the first direction X, and the short side may extend along the second direction Y.

Referring to FIG. 4B, the optical fiber connector 200 includes a second body 201, a plurality of optical fibers 204 and a second alignment component 210. The second alignment component 210 and the first alignment component 110 are magnetically attracted to each other for aligning the optical fibers 204 with the waveguides 106 of the photonic integrated circuit 100. In one embodiment, the second alignment component 210 can be of any shape, such as a rectangle, a square, a circle or a triangle. The second alignment component 210 has, for example, a long side and a short side. The size C3 of the long side is larger than the size C4 of the short side. The long side may extend along the first direction X, and the short side may extend along the second direction Y.

In FIGS. 4A and 4B, the sizes C1 and C3 of the long sides of the first and second alignment components 110 and 210 can be the same, but the sizes C2 and C4 of the short sides can be different, for example, C4>C2 or C2>C4. By changing the attraction positions of the first and second alignment components 110 and 210, the position of the optical fiber connector 200 in the second direction Y can be fine-tuned, and thereby the alignment accuracy in the second direction Y is improved.

In addition, referring to FIG. 4C, a second alignment component 210 of another embodiment is illustrated. The second alignment component 210 has, for example, a long side and a short side, and the size C3 of the long side is larger than the size C4 of the short side. The long side may extend along the second direction Y, and the short side may extend along the first direction X. In FIGS. 4A and 4C, the long sides of the first and second alignment components 110 and 210 are perpendicular to each other, and the size C3 of the long side of the second alignment component 210 in the second direction Y is larger to increase the displacement of optical fiber connector 200. By changing the attraction positions of the first and second alignment components 110 and 210, the position of the optical fiber connector 200 in the second direction Y can be fine-tuned, and thereby the alignment accuracy in the second direction Y is improved.

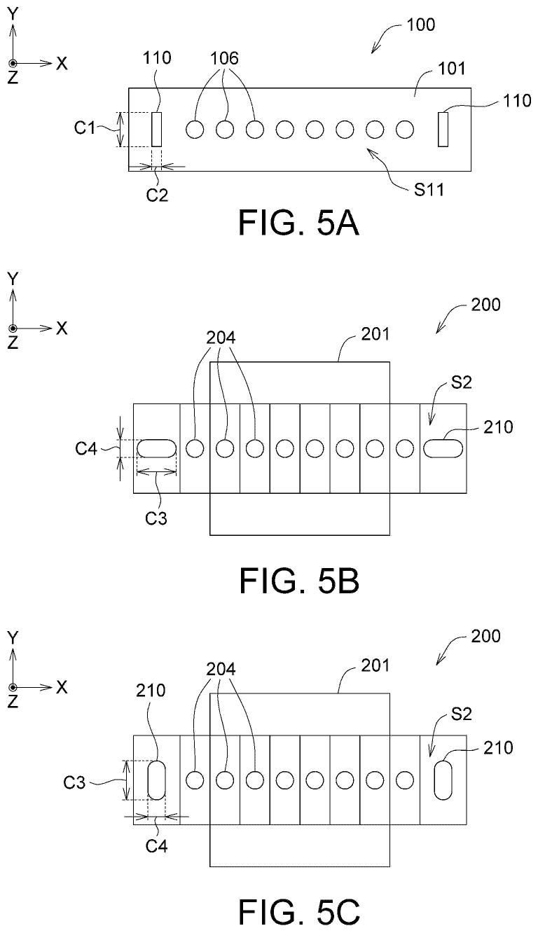

Referring to FIGS. 5A, 5B and 5C, schematic diagrams of two alignment components disposed on the optical fiber connector 200 and the photonic integrated circuit 100 according to another embodiment of the present disclosure are illustrated respectively. In FIG. 5A, the first alignment component 110 has, for example, a long side and a short side, and the size C1 of the long side is larger than the size C2 of the short side. The long side may extend along the second direction Y, and the short side may extend along the first direction X. The arrangement of the second alignment component 210 in FIG. 5B is the same as that in FIG. 4B, and the arrangement of the second alignment component 210 in FIG. 5C is the same as that in FIG. 4C, which do not repeat here.

In FIGS. 5A and 5B, the long sides of the first and second alignment components 110 and 210 are perpendicular to each other, and the size C3 of the long side of the second alignment component 210 in the first direction X is larger to increase the displacement of the fiber optic connector 200. Therefore, by changing the attraction positions of the first and second alignment components 110 and 210, the position of the optical fiber connector 200 in the first direction X can be fine-tuned, and thereby the alignment accuracy in the first direction X is improved.

In FIGS. 5A and 5C, the sizes C1 and C3 of the long sides of the first and second alignment components 110 and 210 can be the same, but the sizes C2 and C4 of the short sides can be different, for example, C4>C2 or C4<C2. By changing the attraction positions of the first and second alignment components 110 and 210, the position of the optical fiber connector 200 in the first direction X can be fine-tuned, and thereby the alignment accuracy in the first direction X is improved.

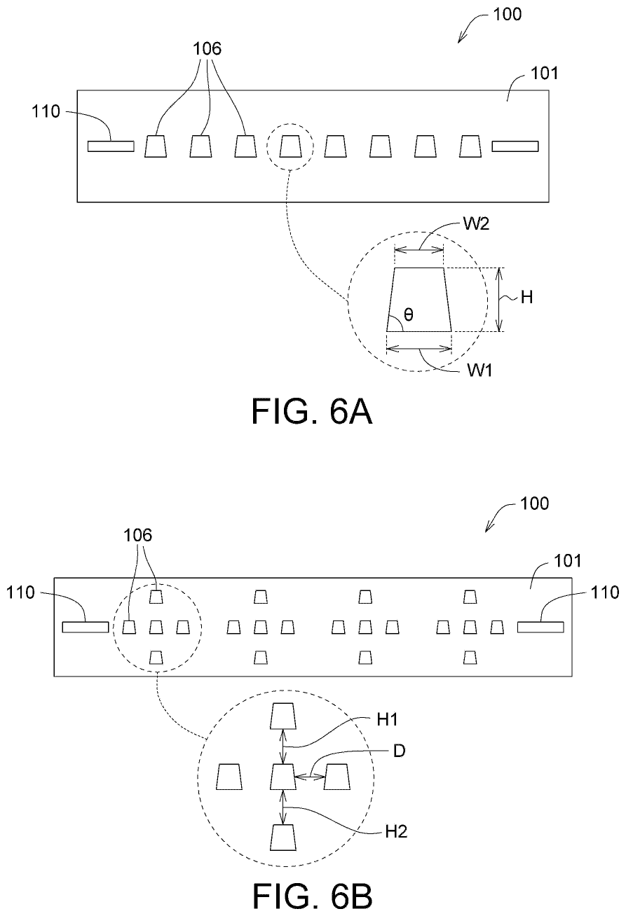

Referring to FIGS. 6A and 6B, the configuration of the waveguides 106 according to an embodiment of the present disclosure are illustrated respectively. In FIG. 6A, the waveguides 106 are disposed in the first body 101, the material of the waveguides 106 may be silicon or SiN, and the material of the first body 101 may be oxide or oxynitride. The refractive index of the waveguides 106 is between about 3.8 and about 4.2, and the refractive index of the first body 101 is between about 2.1 and about 2.4. Since the refractive index of the waveguides 106 is greater than the refractive index of the first body 101, the light can be confined in the waveguides 106 through total reflection between the heterogeneous interfaces for optical communication. In one embodiment, the cross-section of the waveguides 106 is, for example, cylindrical, trapezoidal, circular or other suitable shapes, the height H of the waveguides 106 can be between about 10 nm and about 10 μm, and the width W1 of the waveguide 106 can be between about 50 nm and about 6 μm, the ratio of the upper width W2 and the lower width W1 of the waveguide 106 can be between 50% and 99%. The internal bottom angle θ of the waveguide 106 may be between 30 degrees and 90 degrees.

In FIG. 6A, the waveguides 106 may be a single-layer structure. In FIG. 6B, the waveguides 106 may be a multi-layer structure, such as a two-layer or more than two-layer structure. Each layer of the waveguides 106 can be arranged on different planes and separated by predetermined heights H1, H2 and intervals D, such as between about 50 nm and about 2 μm, so that the light can transmit through the multi-layer waveguides 106 to reduce light loss. In addition, since the waveguides 106 is formed of a multi-layer structure and the number and size of the waveguides 106 can be increased, the cross-sectional area of the waveguides 106 can be increased, so that the size of the optical mode in the photonic integrated circuit 100 can be matched with the size of the optical mode in the optical fiber 204 to improve the stability and reliability of optical transmission quality.

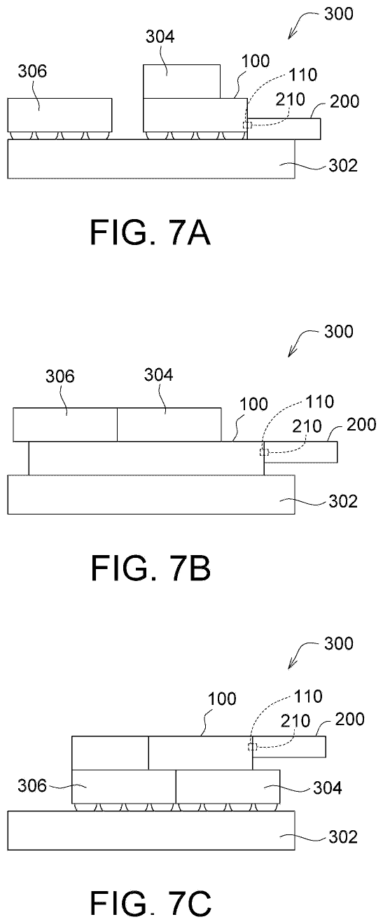

Referring to FIGS. 7A to 7C, schematic diagrams of a photonic packaging structure 300 according to an embodiment of the present disclosure are illustrated respectively. The photonic packaging structure 300 can integrate a silicon photonic chip with a silicon-based integrated circuit to form an optoelectronic packaging structure, and the silicon photonic chip uses optical signals to replace electrical signals, which not only has high transmission efficiency, but also can effectively solve signal loss and heat issues. In addition, the optoelectronic integrated chip generated by highly integrating silicon photonic chips and integrated circuits is also expected to significantly increase data processing speed, reduce power consumption, shrink chip area, save data bit costs, and improve reliability.

In FIG. 7A, the photonic packaging structure 300 includes a substrate 302, an electronic circuit component 304, a photonic integrated circuit 100 (so called as a silicon photonic chip or an integrated optical circuit), an optical fiber connector 200 and two alignment components 110 and 210. The electronic circuit component 304 is disposed on the substrate 302. The photonic integrated circuit 100 is disposed on the substrate 302 and is electrically connected to the electronic circuit component 304. The optical fiber connector 200 is disposed on the photonic integrated circuit 100. The two alignment components 110 and 210 are disposed between the photonic integrated circuit 100 and the optical fiber connector 200. The two alignment components 110 and 210 are configured for the optical fiber connector 200 to be magnetically attracted to the photonic integrated circuit 100.

In FIG. 7A, the electronic circuit component 304 is integrated on the photonic integrated circuit 100. The internal components of the photonic integrated circuit 100 mainly transmit optical signals through optical waveguides 106 to connect active components, passive components and electronic components in sequence on the same silicon chip. In addition, the system-on-chip 306 may be individually disposed on the substrate 302. In FIG. 7B, the system-on-chip 306 and the electronic circuit component 304 are integrated on the photonic integrated circuit 100, and optical signals are transmitted through the optical waveguide 106 to connect active components, passive components and electronic components in sequence on the same silicon chip. The system-on-chip 306 can include a central processing unit (CPU), a graphics processing unit (GPU) and other peripheral interface functional units, which allows electrical signals to be transmitted over a short distance within the same integrated circuit to perform calculations, and thus consuming power is lower and the speed is faster. In FIG. 7C, the photonic integrated circuit 100 is integrated on the system-on-chip 306 and the electronic circuit component 304, and transmits optical signals through the optical waveguides 106 to connect active components, passive components and electronic components in sequence on the same silicon chip.

In addition, in FIGS. 7A to 7C, the two alignment components 110 and 210 are, for example, two magnets or other detachable components. For the arrangement of the two alignment components 110 and 210, please refer to FIGS. 4A to 4C or FIGS. 5A to 5C. The configuration of two alignment components 110 and 210 can be used to adjust the position of the optical fiber connector 200 in the first direction X and/or the second direction Y by changing the attraction positions of the first and second alignment components 110 and 210 to improve the alignment accuracy of the optical fiber connector 200 and the photonic integrated circuit 100.

The present disclosure is related to an optical fiber connector disposed in a detachable manner with high compatibility and stability. The optical fiber connector has high-precision alignment and stable optical performance, and allows for convenient replacement and maintenance of the fiber. For the connection between the PIC and the optical fiber connector, magnets has correction and automatic attraction capabilities to increase reliability without using UV glue to fix the PIC and the optical fiber. Through the use of the extender, the problem of insufficient packaging space can be effectively solved and improve the reliability and stability of the system. For the photonic packaging structure, aligning and adjusting optical fiber connector can effectively reduce damage to the transmission components after packaging as well as improve durability and reduce losses in light transmission.

According to some embodiments of the present disclosure, an optical fiber connector includes a body, a plurality of optical fibers and an alignment component. The body has an interface. The optical fibers are arranged in the body, and the optical fibers are arranged in a first direction of the interface. The alignment component is disposed on the interface and is located on at least one side of the interface in the first direction. The alignment component is configured for the optical fiber connector to be magnetically attracted to another alignment component.

According to some embodiments of the present disclosure, a photonic integrated circuit includes a body, a plurality of waveguides and an alignment component. The body has an interface. The waveguides are disposed in the body, and the waveguides are arranged in a first direction of the interface. The alignment component is disposed on the interface and is located on at least one side of the interface in the first direction. The alignment component is configured for the photonic integrated circuit to be magnetically attracted to another alignment component.

According to some embodiments of the present disclosure, a photonic packaging structure includes a substrate, an electronic circuit component, a photonic integrated circuit, an optical fiber connector and two alignment components. The electronic circuit component is arranged on the substrate. The photonic integrated circuit is disposed on the substrate and electrically connected to the electronic circuit component. The optical fiber connector is arranged on the photonic integrated circuit. The two alignment components are disposed between the photonic integrated circuit and the optical fiber connector, and the two alignment components are configured for the optical fiber connector to be magnetically attracted to the photonic integrated circuit.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical fiber connector, comprising:
a body having an interface;
a plurality of optical fibers disposed in the body, and the optical fibers are arranged in a first direction of the interface; and
an alignment component disposed on the interface and located on at least one side of the interface in the first direction, wherein the alignment component is configured for the optical fiber connector to be magnetically attracted to another alignment component.

2. The optical fiber connector according to claim 1, wherein the two alignment components are magnets.

3. The optical fiber connector according to claim 1, wherein the body comprises a first optical coupling part, the optical fibers comprise a first optical fiber disposed in the first optical coupling part, the first optical fiber and an edge coupler are coupled to couple a light into the first light coupling part in a second direction perpendicular to the first direction.

4. The optical fiber connector according to claim 3, wherein the body further comprises a second optical coupling part, the optical fibers further comprise second optical fibers disposed in the second optical coupling part, and the second optical fiber and a grating coupler are coupled to couple a light into the second light coupling part in a third direction perpendicular to the first direction.

5. The optical fiber connector according to claim 1, further comprising a first buckling part and a second buckling part, the first buckling part and the second buckling part being located on opposite sides of the body, and the body being fastened to another body through the first buckling part and the second buckling part.

6. The optical fiber connector according to claim 1, wherein the two alignment components respectively have a long side and a short side, a size of the long side is larger than a size of the short side, the long side extends along the first direction, and the short side extends along a second direction perpendicular to the first direction.

7. The optical fiber connector according to claim 1, wherein the two alignment components respectively have a long side and a short side, a size of the long side is larger than a size of the short side, and the long sides extend along a second direction perpendicular to the first direction, and the short sides extend along the first direction.

8. A photonic integrated circuit, comprising:
a body having an interface;
a plurality of waveguides disposed in the body, and the waveguides are arranged in a first direction of the interface; and
an alignment component disposed on the interface and located on at least one side of the interface in the first direction, wherein the alignment component is configured for the photonic integrated circuit to be magnetically attracted to another alignment component.

9. The photonic integrated circuit according to claim 8, wherein the two alignment components are magnets.

10. The photonic integrated circuit according to claim 8, further comprising at least one matching element disposed on the interface, wherein the photonic integrated circuit and the matching element are fixedly connected through UV glue or in a non-detachable manner.

11. The photonic integrated circuit according to claim 10, wherein the matching element comprises a first matching element and a second matching element extending along a direction perpendicular to the first direction, and the first matching element has a first refractive index, the second matching element has a second refractive index, wherein the first refractive index is close to a refractive index of the waveguides, and the second refractive index is smaller than the first refractive index.

12. The photonic integrated circuit according to claim 8, wherein the two alignment components respectively have a long side and a short side, a size of the long side is larger than a size of the short side, the long side extends along the first direction, and the short side extends along a second direction perpendicular to the first direction.

13. The photonic integrated circuit according to claim 8, wherein the two alignment components respectively have a long side and a short side, a size of the long side is larger than a size of the short side, and the long sides extend along a second direction perpendicular to the first direction, and the short sides extend along the first direction.

14. A photonic packaging structure, comprising:
a substrate;
an electronic circuit component disposed on the substrate;
a photonic integrated circuit disposed on the substrate and electrically connected to the electronic circuit component;
an optical fiber connector disposed on the photonic integrated circuit; and
two alignment components disposed between the photonic integrated circuit and the optical fiber connector, wherein the two alignment components are configured for the optical fiber connector to be magnetically attracted to the photonic integrated circuit.

15. The photonic packaging structure according to claim 14, wherein the electronic circuit component is integrated on the photonic integrated circuit.

16. The photonic packaging structure according to claim 14, wherein the photonic integrated circuit comprises a first body, a plurality of waveguides and a first alignment component of the two alignment components, the first body has an interface, the waveguides are disposed in the second body, the waveguides are arranged in a first direction of the first interface, the first alignment component is disposed on the first interface and is located on at least one side of the first interface in the first direction.

17. The photonic packaging structure according to claim 16, wherein the optical fiber connector comprises a second body, a plurality of optical fibers and a second alignment component of the two alignment components, the second body has a second interface, the optical fibers are arranged in the first body, and the optical fibers are arranged in the first direction of the second interface, the second alignment component is arranged on the second interface and is located on at least one side of the second interface in the first direction.

18. The photonic packaging structure according to claim 17, wherein the first alignment component and the second alignment component are magnets, and the first alignment component and the second alignment component attract to each other in the first direction or in a second direction perpendicular to the first direction.

19. The photonic packaging structure according to claim 18, wherein the optical fibers and the waveguides are aligned in the first direction or the second direction through the first alignment component and the second alignment component.

20. The photonic packaging structure according to claim 18, wherein the attraction positions of the first alignment component and the second alignment component are changed to adjust the position of the optical fiber connector in the first direction or the second direction.
